(19) United States
(12) Patent Application Publication
(10) Pub. No.: US 2015/0260167 A1
(43) Pub. Date: Sep. 17, 2015

(54) ARRANGEMENT AND METHOD TO ALIGN TWO COMPONENTS

(71) Applicant: SIEMENS AKTIENGESELLSCHAFT, MUNCHEN (DE)

(72) Inventor: JASON STEGE, BRANDE (DK)

(21) Appl. No.: 14/624,043

(22) Filed: Feb. 17, 2015

(30) Foreign Application Priority Data
Mar. 12, 2014 (EP) 14159172.7

(51) Int. Cl. F03D 11/04; H04N 7/18; H04N 5/225; F16B 17/00

(52) U.S. Cl. CPC F03D 11/04; F16B 17/00; H04N 7/183; H04N 5/2257

(57) ABSTRACT

An arrangement and a method to align a first component and a second component is provided. The first component includes guiding means and the second component includes guiding means, while these guiding means are prepared and arranged to interact with each other. The guiding means of the components are prepared and arranged to align the components to each other while the components are moved towards each other for their final connection. The guiding means of the first component includes an optical camera system, which is used to monitor the change of the position of the guiding means of the second component in reference to the position of the guiding means of the first component. The optical camera system is connected with a remote display enabling working personnel to direct the movement of the components based on the monitored position changes.

### CROSS-REFERENCE TO RELATED APPLICATIONS

This application claims priority to European Application No. EP14159172.7, having a filing date of Mar. 12, 2014, the entire contents of which are hereby incorporated by reference.

### BACKGROUND

The following relates to a method and to an arrangement to align a first component and a second component while they are moved towards each other for their final connection.

### FIELD OF TECHNOLOGY

It is known to use guiding means or aligning means like bolts, pins, cylinders, dove-tails or the like for the alignment of heavy and/or huge components for their connection.

By using alignment means, it is possible to move and direct components in a specific position to allow their fixation at each other finally.

FIG. 4 shows one example for this purpose. A wind turbine blade BL is lifted as a first component and in a horizontal orientation by a crane CR.

The crane CR approaches the horizontal blade BL towards the hub HB of a wind turbine, while the hub HB is the second component.

The blade BL might have a weight of several tons and might show a typical diameter of more than 2 meters at its root end RE.

The hub HB might be located at a height of 100 meters and might be connected to a nacelle of the wind turbine. The hub might show a diameter of more than 4 meters and a weight of several tons.

Typically, the hub HB as well as the root end RE of the blade BL comprises a flange. The flanges might be ring-shaped for example.

The flanges will be finally connected by threaded bolts and nuts, while a number of bolts will be used as alignment-bolts to guide the blade, when it is moved towards the hub for its final connection there.

For the alignment movement of the blade towards the hub, a number of bolts might be already positioned at one of the flanges, i.e. at the flange of the blade.

These bolts are often prolonged in view to those bolts, which will be used to finally fix and connect the blade at the hub.

The blade will be approached step-by-step to the hub by the crane CR while the prolonged bolts are used as guiding means.

Service personal ensure that the prolonged bolts, being pre-mounted at the flange of the blade, finally slip in allocated holes of the flange of the hub.

The allocated holes are shaped in an adverse manner in reference to the bolts. The holes receive the prolonged bolts.

As soon as the components are in their dedicated position to each other the prolonged bolts are equipped with nuts and the components hub and blade are fixed together step-by-step.

A set of additional bolts, which are shorter than the prolonged bolts, are used for the final fixation and connection of the components.

The step-by-step movement and the alignment of the components as described above needs to be done quite carefully due to the heavy weight and due to the dimension of the components.

Much time is spent for the controlled movement and for the alignment of the components. Experienced working personal is needed to perform this movement, alignment and fixation work. Thus, the costs and efforts of the work will be high.

Even the weather conditions, especially the wind speed, might limit the number of possible working-days, which are needed to fix a number of blades with the hub.

Those limitations finally result in additional costs as operation time of the wind turbine might get lost due to bad weather conditions during the erection of the wind turbine.

### SUMMARY

Embodiments of the invention provide an improved method and arrangement for joining and aligning especially huge and heavy components in an easy and cheap manner

According to embodiments of the invention, a first component and a second component are aligned. The first component comprises guiding means and the second component comprises guiding means, while these guiding means are prepared and arranged to interact with each other. The guiding means of the components are prepared and arranged to align the components to each other while the components are moved towards each other for their final connection. The guiding means of the first component comprises an optical camera system, which is used to monitor the change of the position of the guiding means of the second component in reference to the position of the guiding means of the first component. The optical camera system is connected with a remote display enabling working personnel to direct the movement of the components based on the monitored position changes.

In a preferred configuration, the guiding means are adverse to each other.

In a preferred configuration, the guiding means of the first component protrudes from a joint face of the first component and projects into a joint surface of the second component.

In a preferred configuration, the guiding means of the first component comprises a threaded bolt or a bolt or a pin. The guiding means of the second component comprises a drill or a hole or a drilled hole.

In a preferred configuration, the optical camera system is integrated and placed into a drilling, which is drilled into the front face of the bolt.

In a preferred configuration, the first component comprises fixation means, which is preferably a flange, while the second component comprises fixation means, which is preferably a flange, too. Both flanges, which are preferably ring-shaped, show drill holes for a connection of the first and the second component by threaded bolts and nuts.

In a preferred configuration, the flange of the first component comprises at least one bolt, which is used as guiding means of the first component, and the bolt comprises the optical camera system.

In a preferred configuration, the bolt, which comprises the optical camera system, is longer than the bolts, which are mainly used to finally connect the first and the second component by threaded bolts and nuts.

In a preferred configuration, the first component is a blade of a wind turbine, and the second component is a hub of a wind turbine.

In a preferred configuration, the optical camera system is a wireless optical camera system, thus gathered optical information like pictures are transferred in a wireless manner from the optical camera system to the display.

Embodiments of the invention allow the aligning and joining of heavy and/or huge components, like the hub of a wind turbine or the blade of the wind turbine, without direct visual observation of working personnel.

Embodiments of the invention allow an operator to remotely align the components during a lifting operation without direct visual confirmation.

There is no need for the operator to place his head between two massive components during their joining as it is done today.

Preferably, the video or a single picture of the video, obtained by the camera system, is transferred to a screen. Thus, the pictures of the video can be reversed, mirrored, changed in their size to show details, or can be otherwise altered. Thus, the remote controlled movement of the components becomes more intuitive.

Embodiments of the invention can be used for crane-based installation procedures as shown in the figures below. For that kind of installation a typical number of 100 bolts need to be aligned and connected, which is a quite high challenge for the crane operator.

Embodiments of the invention allow an increase in safety in lifting or erection operations in a quite easy manner. The operator, doing remote-controlled component movements, is brought out of any dangerous zones.

Embodiments of the invention deliver best perspectives for bolt-and-hole alignments as described herein.

Embodiments of the invention can be implemented and retrofitted into all current systems quite easily and in a cheap manner.

### BRIEF DESCRIPTION

Some of the embodiments will be described in detail, with reference to the following figures, wherein like designations denote like members, wherein:

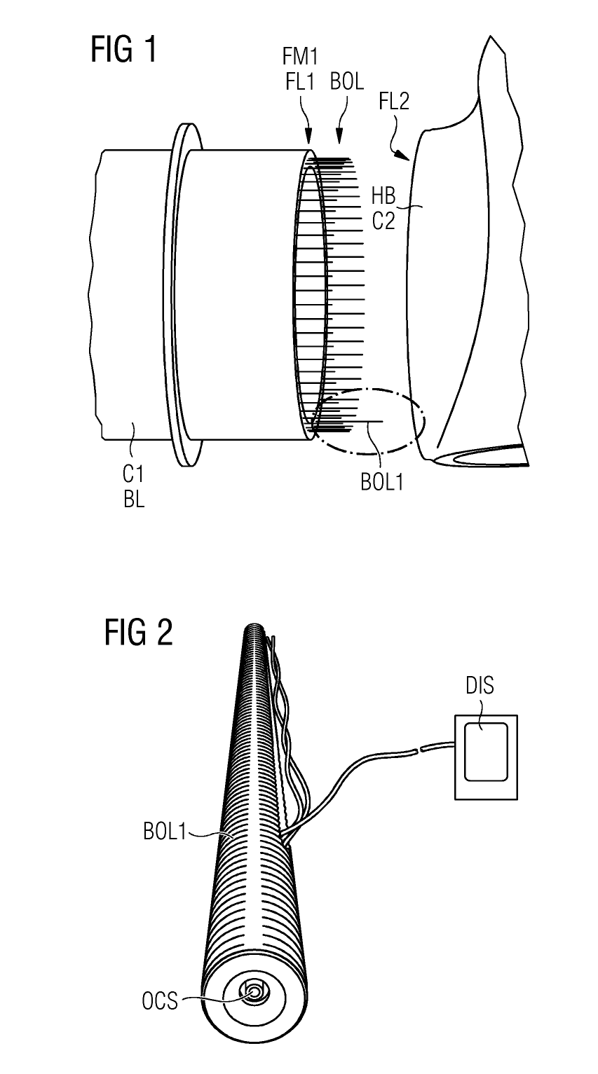

FIG. 1 shows the alignment of a first component and of a second component, which is done based on embodiments of the invention;

FIG. 2 refers to FIG. 1 and shows one bolt in more detail;

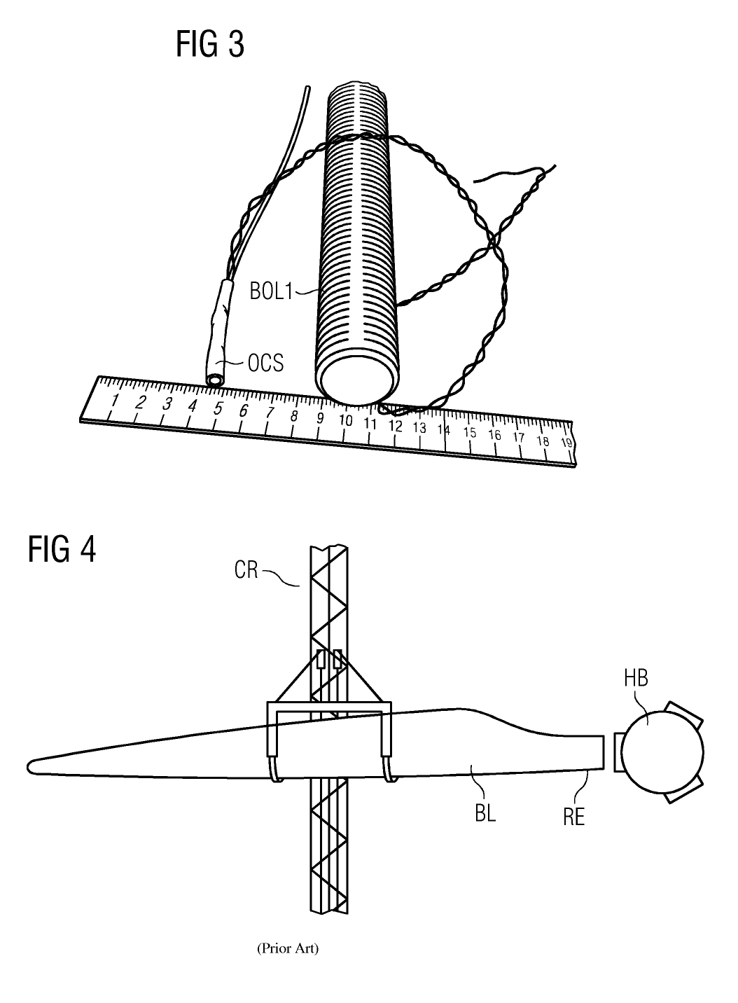

FIG. 3 refers to FIG. 2 and shows the size of the optical camera system in reference to the bolt; and

FIG. 4 shows the joining of a wind turbine blade and a hub according to the prior art known and as described in the introduction of the description.

### DETAILED DESCRIPTION

FIG. 1 shows the alignment of a first component and of a second component, which is done based on embodiments of the invention.

A blade BL of a wind turbine is approached as first component C1 towards a hub HB of the wind turbine, which is the second component C2 according to embodiments of the invention.

The blade BL comprises a number of bolts BOL, which are used as guiding means GMC1 of the first component C1.

The bolts BOL are arranged and are pre-mounted at a flange FL1 of the blade BL. The flange FL1 is used as fixation means FM1 of the first component C1.

Accordingly the hub HB comprises as second component C2 also a flange FL2, which is used as fixation means FM2 of the second component C2.

The flange FL2 of the second component C2 comprises holes (not shown in detail), which are used as guiding means GMC2 of the second component C2. They interact with the bolts BOL of the flange FL1 of the first component C1, when the components C1 and C2 are moved towards each other for their final connection. Thus, the guiding means GMC1 and GMC2 are adverse to each other.

The bolts BOL, being pre-mounted at the first flange FL1, and the holes of the second flange FL2 are used for a threaded bolt-nut-connection, as soon as the components C1 and C2 are aligned and are moved towards each other into a dedicated final position for their final connection.

On the bottom of FIG. 1, there is one prolonged bolt BOL1, which is marked with a circle. This bolt BOL1 is longer than the other bolts BOL, which are mainly used for the final connection of the components C1 and C2.

This bolt BOL1 is also part of the guiding means GMC1 of the first component C1 and additionally comprises an optical camera system, which is explained in more detail in the next figures.

The bolts BOL of the guiding means GMC1 of the first component C1 protrudes from a joint face of the first component C1 and projects into a joint surface of the second component C2, thus the components C1 and C2 can be aligned and moved towards in a guided manner quite easily.

FIG. 2 refers to FIG. 1 and shows the bolt BOL1 in more detail.

A front face of the bolt BOL1 comprises a drilling, in which an optical camera system OCS is located or arranged.

The optical camera system OCS is used to monitor changes of the position of the guiding means GMC2 of the second component C2 in reference to the position of the guiding means GMC1 of the first component.

The optical camera system OCS is connected with a remote display DIS, which is controlled by working personnel.

Thus, the working personnel is enabled to direct the movement of the components C1 and C2 in relation to each other and based on the monitored position changes.

Preferably, the optical camera system OCS is a wireless optical camera system, thus gathered optical information like pictures are transferred in a wireless manner from the optical camera system OCS to the display DIS.

FIG. 3 shows the size and the diameter of the optical camera system OCS in reference to the diameter of the bolt BOL1.

The optical camera system OCS shows a diameter of approximately 5 mm and a length of approximately 35 mm, while the bolt BOL1 shows a diameter of approximately 22 mm. Based on these camera dimensions, it is quite easy to integrate the optical camera system OCS into the bolt BOL1.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. An arrangement to align a first component and a second component, wherein the first component comprises a first guiding means and wherein the second component comprises a second guiding means, which are prepared and arranged to interact with each other, wherein the first guiding means and the second guiding means are prepared and arranged to align the first component and the second component to each other while the first component and the second component are moved towards each other for a final connection, further wherein the first guiding means comprises an optical camera system, which is used to monitor a change of a position of the second guiding means in reference to a position of the first guiding means of the first component, and that the optical camera system is connected with a remote display enabling working personnel to direct the movement of the first component and the second component based on the monitored position changes.

2. The arrangement according to claim 1, wherein the first guiding means and the second guiding means are adverse to each other.

3. The arrangement according to claim 1, wherein the first guiding means protrudes from a joint face of the first component and projects into a joint surface of the second component.

4. The arrangement according to claim 3, wherein the first guiding means comprises a threaded bolt or a bolt or a pin, and wherein the second guiding means comprises a drill or a hole or a drilled hole.

5. The arrangement according to claim 4, wherein the optical camera system is integrated into a drilling, which is drilled into the front face of the bolt.

6. The arrangement according to claim 1, wherein the first component comprises a first fixation means, which is a flange, wherein the second component comprises a second fixation means, which is a flange, and wherein both flanges, which are ring-shaped, show drill holes for a connection of the first component and the second component by threaded bolts and nuts.

7. The arrangement according to claim 6, wherein the flange of the first component comprises at least one bolt, which is used as the first guiding means of the first component, and wherein the bolt comprises the optical camera system.

8. The arrangement according to claim 7, wherein the bolt, which comprises the optical camera system, is longer than the bolts, which are used to finally connect the first component and the second component by threaded bolts and nuts.

9. The arrangement according to claim 1, wherein the first component is a blade of a wind turbine, and wherein the second component is a hub of a wind turbine.

10. The arrangement according to claim 1, wherein the optical camera system is a wireless optical camera system, thus gathered optical information like pictures are transferred in a wireless manner from the optical camera system to the display.

11. A method to align a first component and a second component, while they are moved towards each other for their final connection, wherein a first guiding means of the first component interacts with a second guiding means of the second component, wherein the first guiding means and the second guiding means of the first component and the second component align the first component and the second component to each other while the first component and the second component are moved towards each other for a final connection,
wherein an optical camera system, which is part of the first guiding means of the first component, is used to monitor a change of a position of the second guiding means of the second component in reference to a position of the first guiding means of the first component, and
the working personnel uses a remote display, which is connected with the optical camera system, to direct the movement of the first component and the second component based on the monitored position changes.
